(19) United States
(12) Patent Application Publication
(10) Pub. No.: US 2009/0275406 A1
(43) Pub. Date: Nov. 5, 2009

(54) Dynamic user interface in a gaming system

(75) Inventors: Michael R. Bytnar, Chicago, IL (US); Stephen A. Canterbury, Antioch, IL (US); Benjamin T> Gomez, Chicago, IL (US); James M. Rasmussen, Chicago, IL (US); Matthew J. Ward, Northbrook, IL (US)

Correspondence Address: NIXON PEABODY LLP, 300 S. Riverside Plaza, 16th Floor, CHICAGO, IL, 60606, US

(73) Assignee: WMS GAMING INC

(21) Appl. No.: 11/991,347

(22) PCT Filed: Sep. 5, 2006
(86) PCT No.: PCT/US2006/034446

§ 371 Date: Feb. 29, 2008

Related U.S. Application Data
(60) Provisional application No. 60/715,474, filed on Sep. 9, 2005.

(51) Int. Cl. A63F 13/00; A63F 9/24

(52) U.S. Cl. 463/30; 463/37

(57) ABSTRACT

A dynamically re-configurable input panel for a gaming machine, in one implementation, comprises a plurality of electrical contact regions disposed on the input panel and a plurality of display elements associated with the electrical contact regions, wherein information displayed on the display elements is dynamically re-configurable under game machine software control. In one implementation, the plurality of electrical contact regions comprises a plurality of electrical switches. Each of these switches may have a self-contained, re-configurable display element.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, and more particularly to a dynamic user interface for gaming machines.

### BACKGROUND OF THE INVENTION

Many design considerations for gaming machines are founded in the history of a particular style of game, while other design considerations are determined through surveys, interviews, or simple observation of game players. For a particular game machine, such as a slot machine game or a video poker machine, many players have become used to a particular layout of the pushbuttons, levers, or other input devices that control game operation. Because of these user preferences, game machine manufacturers are somewhat reluctant to change the layout or function of input pushbuttons for a particular game.

Gaming machines have evolved from largely mechanical (or electromechanical) systems to largely electronic ones. The mechanical reels of early slot machines have been replaced by video reel-strips that appear on a high-resolution display. The lever used to initiate play of these early machines has also been replaced by an input device, such as a pushbutton or touch-screen, whose activation can be detected electronically.

In known gaming machines, an input panel, sometimes known as a “button panel,” is generally employed to allow the operator to control particular aspects of the game by depressing only a small number of pushbuttons. The pushbuttons are electromechanical switches that include printed information specific to a particular game. For example, the button panel layout for a slot machine game is significantly different from the layout for a video poker game.

As gaming machines have evolved toward electronic implementations, the functionality of the gaming machine is controlled by software installed within the game machine. Although the software is easily replaced simply by replacing a memory device within the machine, the button panel must also be replaced in order to significantly alter the game machine's functionality. Replacement of the button panel is labor intensive, and the necessity of producing a plurality of button panels, each designed for a particular gaming machine, increases the manufacturing cost of the gaming machine.

### SUMMARY OF THE INVENTION

In one implementation, a dynamically re-configurable input panel for a gaming machine comprises a plurality of electrical contact regions disposed on the input panel and a plurality of display elements associated with the electrical contact regions, wherein information displayed on the display elements is dynamically re-configurable under game machine software control.

According to another implementation, one of the electrical contact regions is a virtual touch pad.

Additional aspects of the invention will be apparent to those of ordinary skill in the art in view of the detailed description of various embodiments, which is made with reference to the drawings, a brief description of which is provided below. The use of the same reference numeral in the drawings is utilized to denote identical or similar elements.

### BRIEF DESCRIPTION OF THE DRAWINGS

FIG. 1 is a perspective view of a gaming machine.

FIG. 2 is an input panel for the gaming machine of FIG. 1.

FIG. 3 is a dynamically re-configurable input panel in accordance with the present invention.

FIG. 4 illustrates a single pushbutton from the panel of FIG. 3.

FIG. 5 illustrates a pyramidal pushbutton geometry.

FIG. 6 illustrates a truncated pyramidal pushbutton geometry.

FIG. 7 depicts a touch-screen display implementation of an input panel in accordance with the present invention.

FIG. 8 shows mounting detail and tactile feedback for the panel of FIG. 7.

FIG. 9 illustrates an alternative implementation of a dynamically re-configurable input panel in accordance with the present invention

### DETAILED DESCRIPTION

Various embodiments of this invention can be utilized. The drawings and descriptions of embodiments of the invention exemplify its principles and are not intended to limit the broad aspect of the invention to only the illustrated embodiments.

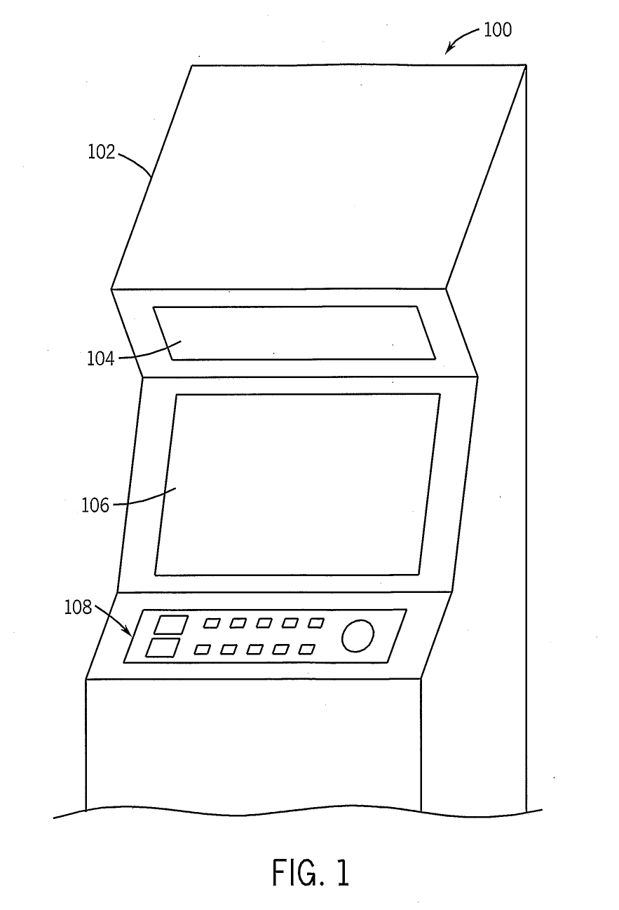

FIG. 1 is a perspective view of a gaming machine 100. The gaming machine includes a housing 102 into which a “top-box” display 104 is installed. A main video display unit 106 is installed in a central location convenient for the operator to both view and touch. This is because the main video display 106 is often a touch-screen incorporating high resolution color display in conjunction with input capability. An input panel 108 is installed in a convenient position so that the user can easily press any desired button. Of course, the arrangement of the panels illustrated in FIG. 1 is not intended to be limiting. The input panel 108 may even be disconnected from the housing and provided as a stand-along unit, and may be in communication with the gaming machine 100 through wireless means, such as an RF (radio frequency) communication channel or an optical communication channel, for example. The display 104 in the top-box portion is often used to display information concerning the title of the game, and may also include graphics or light displays intended to attract patrons to the game machine 100.

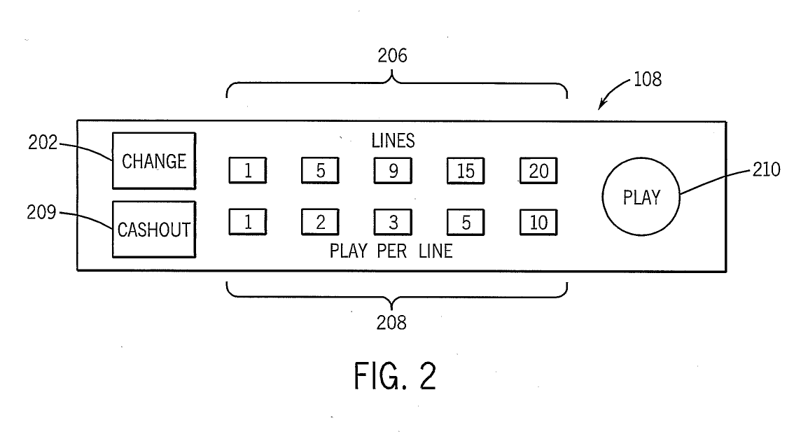

FIG. 2 depicts a particular button panel 108 suitable for a slot machine game. Generally, each electromechanical pushbutton 202-210 is individually backlighted, and the backlighting of each button is independently controllable. For a slot machine game, some of the buttons 206 may be used to control the lines that appear across the video reel-strips that appear on the main display 106. Many combinations are available to the operator, as indicated by the legends “1,” “5,” etc. that appear on these pushbuttons. A second row of buttons 208 allows the operator quick access to the amount of the wager associated with each line, and also activates game play when depressed. Generally, the largest pushbutton on this particular dedicated input panel is the PLAY button 210 that activates the video reel-strips for game play.

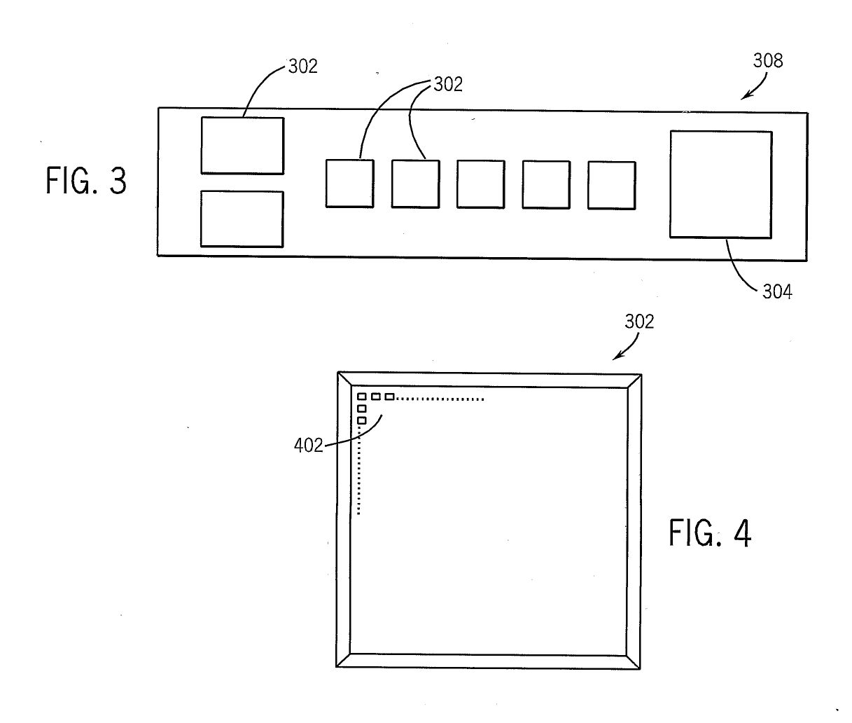

FIG. 3 illustrates a dynamically re-configurable input panel 308 in accordance with the present invention. Each of the pushbuttons 302, 304 has an integral display. Preferably, each display is a dot-matrix LCD (liquid crystal display) with a high display element density and individually controllable backlighting. FIG. 4 illustrates the display region 402 of an individual pushbutton 302. Of course, at least some of the LCD displays disposed on the pushbuttons 302, 304 may be high resolution, active matrix color displays to maximize reprogramming flexibility. Using the input panel 308, the input panel functionality can easily be re-configured under control of the game machine resident software.

Other types of display technology may also be used to form the integral displays discussed above, and different display technologies can also be combined on a single pushbutton. In addition to LCD, contemplated display technologies include LEDs (light emitting diodes), OLEDs (organic light emitting diodes), digital paper, and vacuum fluorescent, among others. It is also possible to make the pushbuttons themselves transparent or translucent, in order to permit viewing of an underlying display area. The display area may also be hidden for effect, such as beneath a semi-transparent surface (a partially mirrored surface, for example) so that display elements are not visible at all unless activated by the game machine resident software.

In fact, input panel functionality can be altered during play of a particular game. Many gaming machines, such as video poker and slot machines, include bonus play within the play of the game itself. These bonus play opportunities allow the player to capitalize on accumulated points, for example, or to take advantage of a particularly good poker hand, to alter a wager to the player's advantage. Consequently, the functionality of a particular pushbutton on the input panel 308 may be altered from direct game play control to bonus element control, with a corresponding change in the text or animation displayed on the face of the pushbutton.

There are many forms of bonus play available in known gaming machines. One such form of bonus play first requires the user to select from among a plurality of bonus types, then requires a selection of particular bonus parameters (amount of wager in the bonus, for example). Under these conditions, the display areas of the five centrally located pushbuttons 302 in FIG. 3 can be programmed to identify each of the plurality of bonus types to allow the user to make his selection. Some of the pushbuttons 302 may not be needed during this selection process, and may be blanked under software control. Animations can also be spread over a number of adjacent pushbuttons 302, both to direct the user to the proper pushbuttons to use in a given mode, or to highlight a particular potential choice. After a particular type of bonus play is selected, the display areas of the pushbuttons 302 can be dynamically re-programmed once again to identify selectable parameters for the selected bonus play segment.

Alternatively, the electromechanical pushbuttons 302, 304 with self-contained display regions illustrated in FIG. 3 may be disposed within a high-resolution display region rather than a simple panel. Since large pushbuttons (such as button 304, for example) can easily be configured to “rock” in multiple directions, initiating unique key closures in each direction, pushbutton 304 may easily be surrounded by legends created on the surrounding display region identifying particular functionality when the pushbutton 304 is depressed on its left side, top, bottom, etc. The legend identifying key closure functionality may also be incorporated on the display disposed on the top of the pushbutton 304 itself, of course.

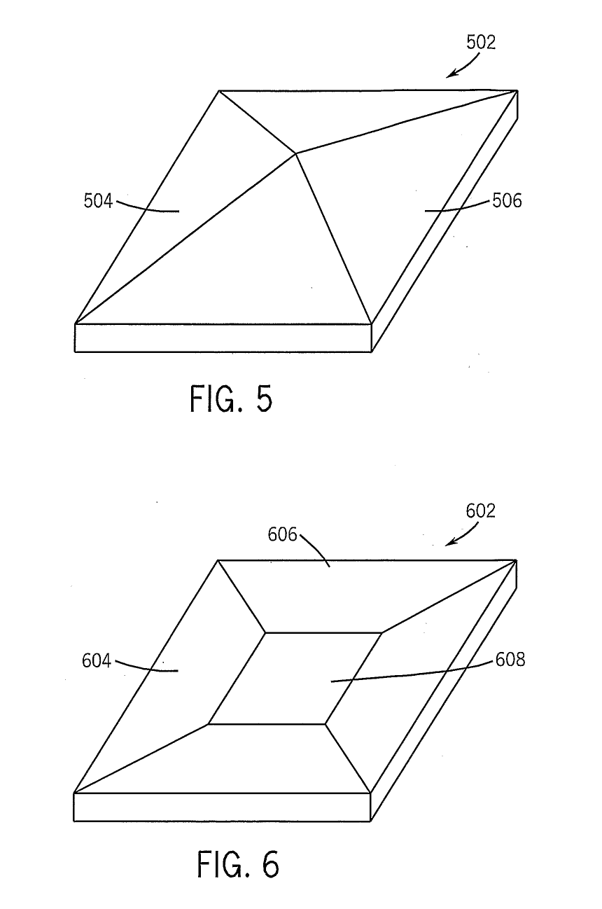

To add yet another dimension to dynamic re-configuration, the individual keys may be given non-planar geometries. FIG. 5 shows a pushbutton switch 502 having a pyramidal geometry. In the event that the pushbutton 502 is intended to be rocked in one of four different directions to achieve one of four different key closures, for example, the pyramidal geometry is relatively intuitive. It is also possible to dispose four different display modules, or four different display regions, each corresponding to one of the “faces” (504, 506, for example) of the pushbutton. These individual displays may be altered dynamically after each detected key closure, to signify entry into a new area of play, for example.

FIG. 6 illustrates a truncated pyramid geometry for a pushbutton 602. In this geometry, each individual surface or facet (604-608, for example) may have individually re-programmable display regions to convey additional information to the player. Displays of legends or animations may be changed based upon fundamental game type (slot machine versus video poker, for example) or altered during the course of the game depending upon a subsidiary mode of operation (bonus, for example).

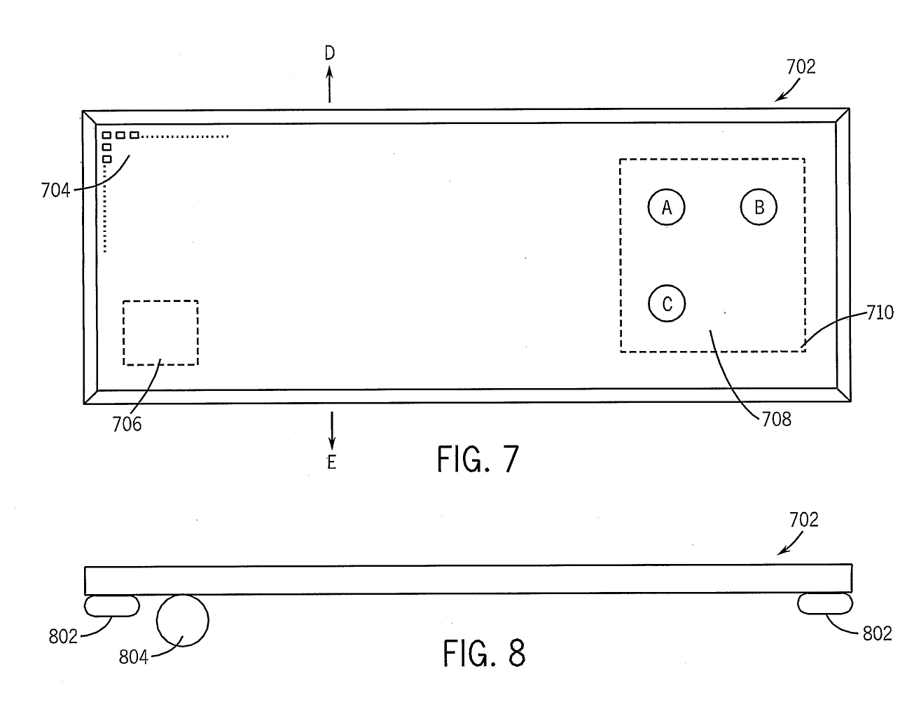

FIG. 7 depicts an input panel 702 (installable in the button panel position 108 of FIG. 1, for example) in which the input “pushbuttons” are effectively virtual. In other words, since the input panel 702 is itself a touch screen, pushbutton 706 is simply created by display of a pushbutton region on the display combined with scanning of the interior area of the pushbutton region 706 for a contact closure. Preferably, the display area 704 is at least a high resolution LCD dot matrix display combined with a touch screen. In the situation where the touch screen display 702 is a high-resolution, active matrix color display, a virtual touch pad 708 can be created on the display, either as a primary or secondary input element for the game machine.

In a high-resolution display, different levels of “transparency” are obtainable. In other words, portions of an underlying display can be permitted to “show through” the touch pad region 708. By scanning within the touch pad region 708 for a contact closure, the resident software of the game machine can determine the precise location of a player's finger (or stylus, if such an implement is used for touch pad manipulation) within the touch pad region. By detection of direction of motion of a finger in contact with the touch pad region, or through detection of a contact proximate a border of the region, for example, the resident software can scroll through an available display. Motion of a finger in the direction of arrow D would initiate scrolling of the underlying display in the direction of arrow D, while motion of a finger in the direction of arrow E would cause the display to scroll in the direction of arrow E. Of course, as noted above, steady contact detected proximate an interior border of the touch pad region can also initiate scrolling in the associated direction.

Since the touch pad region 708 is virtual, it can be resized or translated (moved laterally) under software control in response to a predetermined user input. In an exemplary translation scenario, if two contacts are detected simultaneously a minimum distance apart, such as at points A and B, for example, the virtual touch pad moves laterally in conjunction with detected movement of the two contact points A and B. Of course, other translation control methodologies are also possible. For resizing the touch pad region 708, the resident software may look for three simultaneous contacts that are mutually a minimum distance apart, then resize the touch pad region 708 when contact region C is moved with respect to stationary contact regions A and B. Of course, the foregoing is merely exemplary, and other methods exist for controlling the resizing of the touch pad region 708. In fact, merely contacting the touch pad region near an extremity 710 may be used to initiate a translation or resize process.

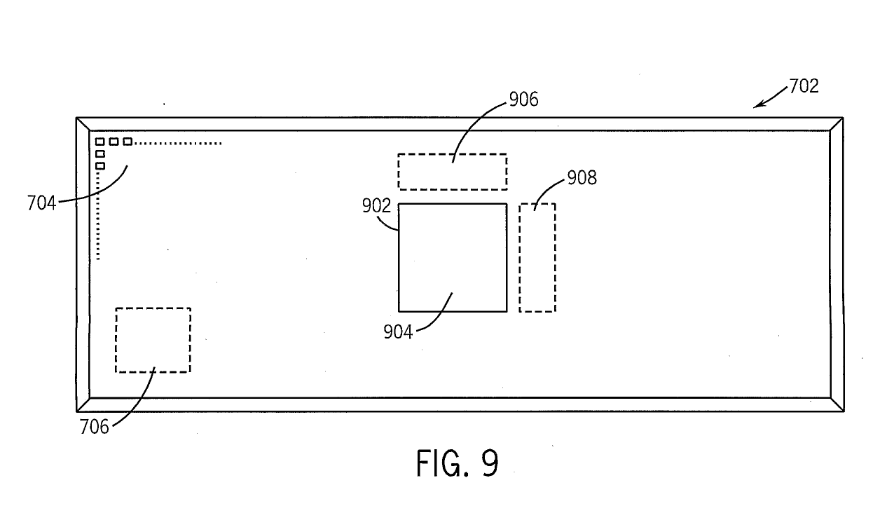

It is also contemplated that the input panel 702 may include electromechanical pushbuttons 902 as illustrated in FIG. 9. The electromechanical pushbutton 902 may or may not include an integral display area on its upper surface 904. The input panel 702 includes a display area 704 disposed substantially throughout its upper surface. The display technology may be high-resolution LCD display, for example, or the technology may be selected from among the various display technologies set forth previously. In this implementation, a combination of electromechanical pushbuttons 902 may be used with virtual pushbuttons 706, since the input panel 702 may also include a touch screen.

Information relating to the function of a particular pushbutton 902 may be displayed in areas (906, 908, for example) adjacent to, or even surrounding, the pushbutton 902. In order to allow for installation of an electromechanical pushbutton, the display area 704 may have an opening disposed therethrough to accommodate the pushbutton 902. In the alternative, since it is contemplated that the input panel 702 may include a touch screen, a mechanical pushbutton may simply be disposed above the touch screen surface, such that depressing the pushbutton causes a detectable electrical contact in the touch screen itself.

FIG. 8 is a side view of the input panel 702 that illustrates a way in which some measure of tactile feedback may be provided to an operator. As indicated, resilient mounting elements 802 are provided for attachment of the input panel 702 to a housing. The resilient mounting elements may be rubber grommets, for example. An electric motor 804 with an eccentric flywheel is used to initiate a relatively low frequency vibration of the input panel 702 that the operator will readily feel. With proper burst control for the duration of a pulse of vibration, the user will interpret this sensation as tactile feedback that a key closure within a virtual pushbutton region 706 has been detected. As an alternative to the use of the eccentric flywheel vibrator 804 described above, an acoustic vibration device may be employed, for example. Of course, any number of virtual pushbuttons 706 can be created within the confines of the input panel 702, and both graphic legends and animations can be altered at any time to signify a change in game play mode, or to introduce another array of possible selections for the player.

While dynamic re-configuration of an input panel has been described in conjunction with installation of new gaming software for a particular gaming machine, it is contemplated that input panel configuration information can also be bundled with game application software. When new game software is downloaded into a gaming machine, the input panel then auto-configures. Input panel configuration information is thus a downloadable asset, just like the game itself. In a downloadable gaming system where gaming machines are networked to a game server (either hard-wired or through a wireless communication channel), the game server houses and distributes gaming application software to the networked gaming machines. The gaming software includes input panel configuration information (software) which is uploaded by the gaming machine to configure the input panel for play of that particular game. Each of these embodiments and obvious variations thereof is contemplated as falling within the spirit and scope of the claimed invention, which is set forth in the following claims.

1. A dynamically re-configurable input panel for a gaming machine comprising:
a plurality of electrical contact regions disposed on the input panel, wherein the plurality of electrical contact regions comprises a plurality of electrical switches with at least a first electrical switch having a multi-faceted geometry; and
a plurality of display elements associated with the electrical contact regions;
wherein information displayed on the display elements is dynamically re-configurable under game machine software control.

2. The dynamically re-configurable input panel of claim 1, wherein the first electrical switch comprises a self-contained, re-configurable display element that displays different indicia for each of the multi-faceted geometries of the first electrical switch.

3. The dynamically re-configurable input panel of claim 2, wherein the self-contained, re-configurable display element comprises an LCD display.

4. The dynamically re-configurable input panel of claim 3, wherein the LCD display comprises an active matrix color LCD display.

5. The dynamically re-configurable input panel of claim 2, wherein the dynamically re-configurable display element is implemented in a display technology selected from the group of display technologies consisting of:
liquid crystal;
light emitting diode;
organic light emitting diode;
digital paper; and
vacuum fluorescent.

6. The dynamically re-configurable input panel of claim 1, wherein each of the multi-faceted geometries of the first electrical switch comprises a planar geometry.

7. The dynamically re-configurable input panel of claim 1, wherein each of the multi-faceted geometries of the first electrical switch generates a corresponding different switch output when the associated multi-faceted geometries of the first electrical switch are activated by a user.

8. The dynamically re-configurable input panel of claim 1, wherein the multi-faceted geometry comprises a pyramidal geometry.

9. The dynamically re-configurable input panel of claim 1, wherein the multi-faceted geometry comprises a truncated pyramidal geometry.

10. The dynamically re-configurable input panel of claim 1, wherein self-contained, re-configurable display elements are disposed on each of the facets of the multi-faceted switches.

11. The dynamically re-configurable input panel of claim 1, wherein the plurality of electrical contact regions comprises a plurality of electrical contact regions created on a touch screen display panel.

12. The dynamically re-configurable input panel of claim 11, wherein one of the electrical contact regions is a virtual touch pad.

13. The dynamically re-configurable input panel of claim 12, wherein the virtual touch pad is at least partially transparent to underlying display content.

14. The dynamically re-configurable input panel of claim 13, wherein the virtual touch pad is laterally translatable and re-sizable.

15. The dynamically re-configurable input panel of claim 14, wherein the virtual touch pad is laterally translatable and re-sizable through detection of a plurality of substantially simultaneous electrical contacts detected at laterally spaced predetermined minimum intervals.

16. The dynamically re-configurable input panel of claim 12, wherein the virtual touch pad is disposed amidst information content on the touch screen display panel.

17. The dynamically re-configurable input panel of claim 16, wherein a predetermined manner of electrical contact detected within the virtual touch pad region initiates scrolling operation of the information content.

18. A dynamically re-configurable input panel for a gaming machine comprising:
a touch screen display panel having a plurality of virtual electrical contact regions displayed thereon, wherein the plurality of virtual electrical contact regions act as corresponding electrical switches with at least a first electrical switch having a multi-faceted geometry;
wherein information content and virtual electrical contact regions displayed on the display panel are dynamically re-configurable under game machine software control.

19. The dynamically re-configurable input panel of claim 18, wherein one of the electrical contact regions is a virtual touch pad.

20. The dynamically re-configurable input panel of claim 19, wherein the virtual touch pad is laterally translatable and re-sizable through detection of a plurality of substantially simultaneous electrical contacts detected at laterally spaced predetermined minimum intervals.

21. A gaming machine comprising:
a dynamically re-configurable input panel spaced apart from a main video display unit of the gaming machine, the input panel having a plurality of electrical contact regions disposed thereon, wherein the plurality of electrical contact regions comprise a plurality of electrical switches with at least a first electrical switch having a multi-faceted geometry; and
a plurality of display elements associated with the electrical contact regions;
wherein information displayed on the display elements is dynamically re-configurable under gaming machine software control.

22. A dynamically re-configurable input panel for a gaming machine comprising:
a touch screen display panel spaced apart from a main video display unit of the gaming machine, the touch screen display panel having a plurality of virtual electrical contact regions displayed thereon, wherein the plurality of virtual electrical contact regions act as corresponding electrical switches with at least a first electrical switch having a multi-faceted geometry;
wherein information content and virtual electrical contact regions displayed on the display panel are dynamically re-configurable under gaming machine software control.
